(19) United States
(12) Patent Application Publication
(10) Pub. No.: US 2005/0225862 A1
(43) Pub. Date: Oct. 13, 2005

(54) Light diffuser having a light diffusion layer

(76) Inventor: Shih-Chieh Tang, Tainan (TW)

Correspondence Address: BACON & THOMAS, PLLC, 625 SLATERS LANE, FOURTH FLOOR, ALEXANDRIA, VA, 22314, US

(21) Appl. No.: 10/821,881

(22) Filed: Apr. 12, 2004

(51) Int. Cl. F21V 7/04; G02F 1/1335; G02B 5/02; G02B 13/20

(52) U.S. Cl. 359/599; 359/707

(57) ABSTRACT

A light diffuser having a light diffusion layer comprises a glass substrate and a diffusion particle layer. The glass substrate consists of a first surface and a second surface at its either side. The diffusion particle layer is directly disposed on the second surface of the glass substrate to simplify the construction of the light diffuser, and a plurality of diffusion particles are dispersed in the diffusion particle layer.

### BACKGROUND OF THE INVENTION

1. Field of the Invention

The present invention relates to a light diffuser having a light diffusion layer. More particularly, the present invention relates to a glass substrate incorporating with a diffusion particle layer to form a unitary light diffusion layer for light refraction that improves entire optical characteristic of the light diffuser.

2. Description of the Related Art

Referring initially to FIG. 1, a conventional light diffuser consists of a transparent substrate 10 which is formed with a fine particle layer. The fine particle layer includes a plurality of fine particles 11 dispersed in the transparent substrate 10. In comparison with material of the transparent substrate 10, the fine particle 11 has a relative refractive index such that it can refract light so as to diffuse light. The transparent substrate 10 is made of material selected from a group consisting of polycarbonate, acrylate or the like etc. The transparent substrate 10 has a specific thickness extending between a first surface and a second surface thereof. The fine particle 11 of the transparent substrate 10 may refract light an appropriated angle when light passes through the transparent substrate 10 between the first surface and the second surface.

However, if the material of the transparent substrate 10 is made of polycarbonate, the construction and material of the transparent substrate 10 may be easily warped and yellowed after long-term use. Alternatively, if the material of the transparent substrate 10 is made of acrylate, the construction of the transparent substrate 10 may also be warped after long-term use. Consequently, it results in a decrease of useful life of the light diffuser. However, employing a glass substrate may avoid warpage and yellowing of the transparent substrate 10.

Referring to FIG. 2, U.S. Pat. No. 6,462,888, issued to Sevant et al. on Oct. 8, 2002, discloses a diffuser master consists of a glass substrate 20. The glass substrate 20 has a first surface 20a and a second surface 20b at its either side. The first surface 20a forms a transparent layer 21 while the second surface 20b forming a diffusion layer 22 such that the transparent layer 21 and the diffusion layer 22 are incorporated. In manufacture, a buffing material, such as aluminum oxide, silicon carbide and ceriumoxide, is disposed on the second surface 20b and a rotary shaft (not shown) connected to a computer system (not shown) rotates to work the buffing material cutting into the second surface 20b. Consequently, the second surface 20b is formed with a surface relief structure of the diffusion layer 22. Alternatively, an acid or alkali agent, such as hydrochloric acid, hydrofluoric acid, ammonium fluoride, potassium hydroxide or sodium hydroxide is poured on the second surface 20b of the glass substrate 20.

In use, light may enter the glass substrate 20 and transmit from the first surface 20a to the second surface 20b. Finally, the second surface 20b of the glass substrate 20 may generate diffused light. Light is substantially refracted an appropriated angle when it passes through the diffusion layer 22 of the glass substrate 20.

Also, U.S. Pat. No. 6,462,888 discloses a manufacturing method for mechanically processing the second surface 20b of the glass substrate 20 to form the diffusion layer 22. Inevitably, the mechanically processing, however, may cause specific damage or weakness of the entire structure of the glass substrate 20. To avoid this task, there is a need of a specific thickness of the glass substrate 20. Consequently, the diffusion layer 22 of the glass substrate 20 may sophisticate the overall manufacturing method and degrade its product quality.

The present invention intends to provide a light diffuser having a light diffusion layer which forms with a diffusion particle layer directly disposed on a glass substrate. Such a configuration of the light diffusion particle layer can avoid inappropriate mechanically operating and reduce the entire thickness of the glass substrate in such a way to mitigate and overcome the above problem.

### SUMMARY OF THE INVENTION

The primary objective of this invention is to provide a light diffuser having a light diffusion layer which forms with a diffusion particle layer directly disposed on a glass substrate. Thereby, the light diffusion layer simplifies the entire manufacturing method for the light diffuser.

The light diffuser in accordance with the present invention comprises a glass substrate and a diffusion particle layer. The glass substrate consists of a first surface and a second surface at its either side. The diffusion particle layer is directly disposed on the second surface of the glass substrate to simplify the construction of the light diffuser, and a plurality of diffusion particles are dispersed in the diffusion particle layer.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a cross-sectional view of a light diffuser in accordance with the prior art;

FIG. 2 is a cross-sectional view of a diffuser master of U.S. Pat. No. 6, 462,888 in accordance with the prior art;

FIG. 3 is a cross-sectional view of a light diffuser having a light diffusion layer in accordance with a first embodiment of the present invention;

FIG. 4 is a cross-sectional view, similar to FIG. 3, of a light diffuser having a light diffusion layer in accordance with a second embodiment of the present invention; and

FIG. 5 is a cross-sectional view, similar to FIG. 3, of a light diffuser having a light diffusion layer in accordance with a third embodiment of the present invention.

### DETAILED DESCRIPTION OF THE INVENTION

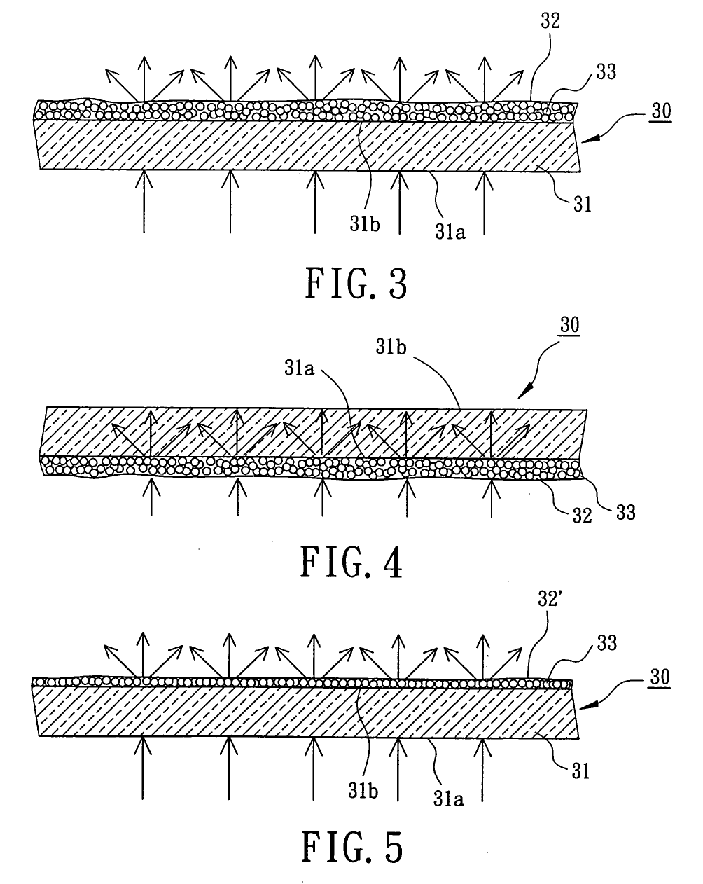

Turning now to FIG. 3, a light diffuser 30 in accordance with the first embodiment of the present invention includes a glass substrate 31 and a diffusion particle layer 32. The glass substrate 31 is employed to support the diffusion particle layer 32. In construction, the glass substrate 31 consists of a first surface 31a and a second surface 31b at its either side, and the first surface 31a is corresponding to the second surface 31b. Preferably, the glass substrate 31 has a film construction and a predetermined thickness extending between the first surface 31a and the second surface 31b. Desirably, the material of the glass substrate 31 is relatively rigid and strong to withstand normal usage. Also, the material of the glass substrate 31 is warpage-resistance and yellow-resistance. However, materials of the glass substrate 31 can be selected from a group consisting of flint glass, crown, phosphate, barium crown and borosilicate.

Still referring to FIG. 3, construction of the diffusion particle layer 32 shall be described in detail. The diffusion particle layer 32 is made of macromolecular compounds and consists of diffusion particles 33 dispersed therein. A method for forming the macromolecular compound is selected from a group consisting of spraying, roller coating and screen-printing. In operating, the macromolecular compounds initially coats on the second surface 31b of the glass substrate 30. The macromolecular compound disposed on the second surface 31b of the glass substrate 30 has a thickness that is adequate to contain the diffusion particles 33. To simplify the construction of the light diffuser 30, the diffusion particle layer 32 is directly disposed on the second surface 31b of the glass substrate 31. To avoid light leakage with respect to a horizontal plane of the second surface 31b of the glass substrate 31, the diffusion particles 33 is uniformly dispersed and stacked each other in the diffusion particle layer 32 to constitute a light diffusion layer.

In manufacture the diffusion particles 33 preferably employ an electrostatic induction method that the macromolecular compound disposed on the second surface 31b of the glass substrate 32 attracts the electrostatic charged particles 33. Alternatively, the mixture of the macromolecular compound and the diffusion particles 33 is coated on the second surface 31b of the glass substrate 31. When the macromolecular compound is hardened, the diffusion particles 33 are automatically embedded in the macromolecular compound.

Still referring to FIG. 3, construction of the diffusion particles 33 shall be described in detail. The diffusion particles 33 have a predetermined diameter and configuration. In comparison with the material of the glass substrate 31, the material of each of the diffusion particles 33 has a relative refractive index such that the light diffuser 30 can refract light to generate light diffusion.

In use, light may enter the first surface 31a of the glass substrate 30 and longitudinally transmit from the first surface 31a to the second surface 31b. Finally, when the light passed through the diffusion particle layer 32, it may generate diffused light.

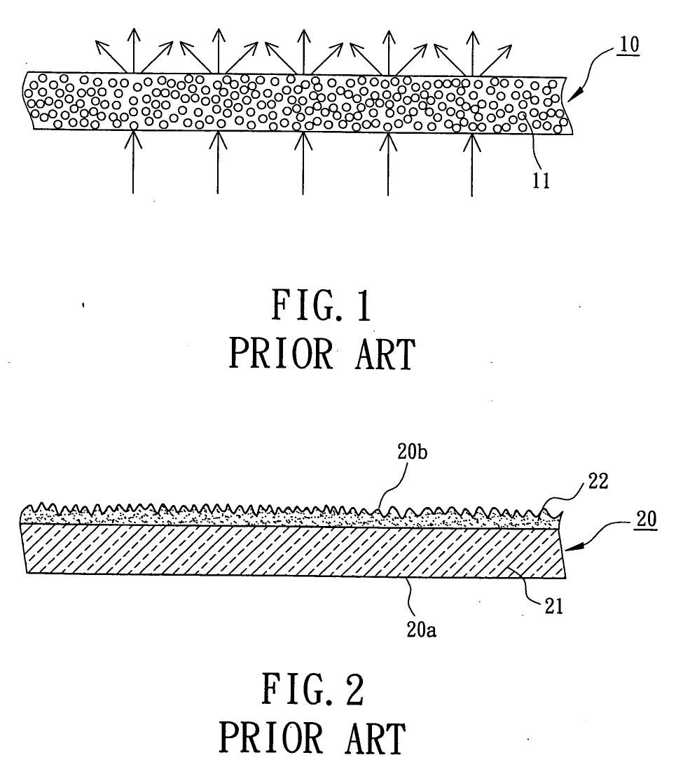

Referring back to FIGS. 1 and 3, the conventional light diffuser 10 made of polycarbonate or acrylate may be easily warped and yellowed after long-term use. However, the combination of the glass substrate 31 with the diffusion particle layer 32 can avoid warpage and the material of the glass substrate 31 can avoid yellowing.

Referring back to FIGS. 2 and 3, the mechanically processing may cause specific damage or weakness of the entire structure of the second surface 20b of the conventional glass substrate 20, and it may sophisticate the overall manufacturing method and degrade its product quality.

Turning now to FIG. 4, reference numerals of the second embodiment of the present invention have applied the identical numerals of the first embodiment. The construction of the light diffuser in accordance with the second embodiment of the present invention has similar configuration and same function as that of the first embodiment and detailed descriptions may be omitted.

Still referring to FIG. 4, as is known in the first embodiment, a light diffuser 30 of the second embodiment includes a glass substrate 31 and a diffusion particle layer 32.

Referring back to FIGS. 3 and 4, in comparison with the first embodiment, the diffusion particle layer 32 of the second embodiment is directly disposed on the first surface 31a of the glass substrate 31. Namely, the diffusion particle layer 32 is inverse-arranged on the glass substrate 31. In use, light may enter the diffusion particle layer 32 of the glass substrate 30, and in consequence diffused light may longitudinally transmit from the first surface 31a to the second surface 31b.

Turning now to FIG. 5, reference numerals of the third embodiment of the present invention have applied the identical numerals of the first embodiment. The construction of the light diffuser in accordance with the third embodiment of the present invention has similar configuration and same function as that of the first embodiment and detailed descriptions may be omitted.

Still referring to FIG. 5, as is known in the first embodiment, a light diffuser 30 of the third embodiment includes a glass substrate 31 and a diffusion particle layer 32′. In comparison with the first embodiment, the diffusion particle layer 32′ of the third embodiment is used to reduce its entire thickness of the light diffuser 30. To this end, the diffusion particle layer 32′ has a desired thickness as thin as possible. Also, the diffusion particles 33 contained in the diffusion particle layer 32′ are made of material as adequate a refractive index as possible.

Referring back to FIGS. 3 and 5, the diffusion particle layer 32′ consists of a single row of diffusion particles 33. The single row of the diffusion particles 33 has at least 85% of the spreading area of the second surface 32B of the glass substrate 31. To avoid piling up the diffusion particles 33 with respect to a horizontal plane of the second surface 31b of the glass substrate 31, each of the diffusion particles 33 is gradually arranged on and adhered to the glass substrate 31.

Although the invention has been described in detail with reference to its presently preferred embodiment, it will be understood by one of ordinary skill in the art that various modifications can be made without departing from the spirit and the scope of the invention, as set forth in the appended claims.

1. A light diffuser having a light diffusion layer comprising:
a glass substrate consisting of a first surface and a second surface corresponding to the first surface; and
a diffusion particle layer including macromolecular compound and a plurality of diffusion particles dispersed therein, the diffusion particle layer is attached to either of the first surface or the second surface of the glass substrate;
the diffusion particles having a relative refractive index with respect to that of the glass substrate so as to refract light an appropriated angle;
wherein light can enter either of the first surface or the second surface of the glass substrate, and passes through the diffusion particle layer to generate a diffused light.

2. The light diffuser having the light diffusion layer as defined in claim 1, wherein the glass substrate can be selected from a group consisting of flint glass, crown, phosphate, barium crown and borosilicate.

3. The light diffuser having the light diffusion layer as defined in claim 1, wherein the diffusion particle layer is made of macromolecular compounds initially coating on the glass substrate.

4. The light diffuser having the light diffusion layer as defined in claim 1, wherein the diffusion particles have a predetermined diameter and configuration.

5. The light diffuser having the light diffusion layer as defined in claim 1, wherein the diffusion particle layer consists of a single row of the diffusion particles.

6. The light diffuser having the light diffusion layer as defined in claim 1, wherein the diffusion particles employ an electrostatic induction method that the macromolecular compound disposed on the glass substrate attracts the electrostatic charged particles.
